(19) United States
(12) Patent Application Publication
(10) Pub. No.: US 2020/0182635 A1
(43) Pub. Date: Jun. 11, 2020

(54) AUTOMATICALLY DETERMINING WAYPOINTS ALONG A ROUTE OF TRAVEL

(71) Applicant: Nuance Communications, Inc., Burlington, MA (US)

(72) Inventors: Hendrik Zender, Wendel (DE); Michael Kaisser, Stuttgart (DE)

(21) Appl. No.: 16/211,793

(22) Filed: Dec. 6, 2018

(51) Int. Cl. G01C 21/34; G06F 16/9537; G06F 16/29; G06F 16/2457; G06F 16/9538; G01C 21/36

(52) U.S. Cl. CPC G01C 21/3415; G06F 16/9537; G06F 16/29; G01C 21/3664; G06F 16/9538; G01C 21/3484; G06F 16/24578

(57) ABSTRACT

Disclosed herein are systems and methods for assisting a driver to plan and carry out individualized/personalized trips in a vehicle, determining appropriate stops for refueling (or recharging) and resting, which can lead to increased driver satisfaction and safety. An example embodiment includes a user interface, vehicle interface, navigation interface, and a processor in communication with the user interface, vehicle interface, and navigation interface. The user interface is configured to present information to a driver of the vehicle and to accept input from the driver. The vehicle interface is configured to determine an amount of fuel remaining in the vehicle. The navigation interface is configured to determine a route of travel and determine positioning coordinates of the vehicle. The processor is configured to determine at least one candidate waypoint to add to the route of travel based on the amount of fuel remaining in the vehicle and driver preference factors. The processor is further configured to cause the user interface to present the at least one candidate waypoint.

### BACKGROUND

A trip in a vehicle typically consists of a route leading from an origin to a destination. Traditional in-vehicle satellite navigation systems allow a driver to specify a set of fixed waypoints. In practice however, many stop-overs that become necessary during a trip are often dynamic in nature and depend on driving circumstances that may change during the trip. For example, vehicles need to stop to refuel (or recharge batteries) before running empty, drivers and passengers need to stop at certain intervals to eat or for bio breaks and in order to prevent drowsy driving.

### SUMMARY

Disclosed herein are systems and methods for assisting a driver to plan and carry out individualized/personalized trips in a vehicle. Embodiments can determine appropriate stops for refueling/recharging and resting, finding waypoints (also referred to herein as points of interest, or POIs) along the way using personalized smart searches, leading to increased driver satisfaction and safety.

One example embodiment is a system for automatically determining waypoints along a vehicle route of travel. The example system includes a user interface, vehicle interface, navigation interface, and a processor in communication with the user interface, vehicle interface, and navigation interface. The user interface is configured to present information to a driver of the vehicle and to accept input from the driver. The vehicle interface is configured to determine an amount of fuel remaining in the vehicle. The navigation interface is configured to determine a route of travel and determine positioning coordinates of the vehicle. The processor is configured to determine at least one candidate waypoint to add to the route of travel based on the amount of fuel remaining in the vehicle and driver preference factors. The processor is further configured to cause the user interface to present the at least one candidate waypoint.

In some embodiments, the vehicle interface can be further configured to determine information regarding a drowsiness level of the driver, in which case the processor can be further configured to determine at least one candidate waypoint based on the drowsiness level of the driver.

The system can also include a waypoint information interface configured to determine information regarding candidate waypoints, in which case the processor can be further configured to determine at least one candidate waypoint based on whether an establishment at a waypoint is open at an estimated time of arrival at the waypoint.

Another example embodiment is a vehicle that includes a user interface, fuel system interface, navigation system, and processor in communication with the user interface, fuel system interface, and navigation system. The user interface is configured to present information to a driver of the vehicle and to accept input from the driver. The fuel system interface is configured to determine an amount of fuel remaining in the vehicle. The navigation system is configured to determine a route of travel and determine positioning coordinates of the vehicle. The processor is configured to determine at least one candidate waypoint to add to the route of travel based on the amount of fuel remaining in the vehicle and driver preference factors. The processor is further configured to cause the user interface to present the at least one candidate waypoint.

The vehicle can further include a driver drowsiness detector configured to determine information regarding a drowsiness level of the driver, in which case the processor can be further configured to determine at least one candidate waypoint based on the drowsiness level of the driver.

The vehicle can further include a computer network interface configured to determine information regarding candidate waypoints, in which case the processor can be further configured to determine at least one candidate waypoint based on whether an establishment at a waypoint is open at an estimated time of arrival at the waypoint.

In the above system and vehicle embodiments, the driver preference factors can include a price factor or a convenience factor. The processor can be further configured to determine scores for a plurality of candidate waypoints based on the driver preference factors, and to cause the user interface to present a list of candidate waypoints having the highest scores. The processor can be further configured to update the driver preferences based on a selection, via the user interface, of a candidate waypoint by the driver. The user interface can be a touch screen interface or voice interface.

Another example embodiment is a method of automatically determining waypoints along a vehicle route of travel. The example method includes determining a set of candidate waypoints along the route of travel, and reducing the set of candidate waypoints based on information regarding the vehicle or driver of the vehicle. The method further includes determining scores for candidate waypoints remaining in the set of candidate waypoints based on driver preference factors, and presenting at least one candidate waypoint to the driver based on the scores for the candidate waypoints.

Reducing the set of candidate waypoints can include removing a candidate waypoint from the set of candidate waypoints if the candidate waypoint is not reachable. Determining whether a candidate waypoint is reachable can be based on an amount of fuel remaining in the vehicle, level of driver drowsiness, or whether an establishment at the candidate waypoint is open at an estimated time of arrival at the candidate waypoint.

Determining scores for candidate waypoints can include determining a score for a candidate waypoint based on a price factor or a convenience factor, and presenting the at least one candidate waypoint to the driver can includes presenting a list of candidate waypoints having the highest scores. The method can further include updating the driver preferences based on a selection of a candidate waypoint by the driver.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram illustrating a system for automatically determining waypoints along a vehicle route of travel, according to an example embodiment.

FIG. 2 is a block diagram illustrating vehicle subsystems for automatically determining waypoints along a vehicle route of travel, according to an example embodiment.

FIG. 3 is a flow diagram illustrating a method of automatically determining waypoints along a vehicle route of travel, according to an example embodiment.

FIG. 4 is a flow diagram illustrating a method of automatically determining waypoints along a vehicle route of travel, according to an example embodiment.

FIG. 5 illustrates an example user interface of a system for automatically determining waypoints along a vehicle route of travel.

FIG. 6 illustrates an example user interface of a system for automatically determining waypoints along a vehicle route of travel.

### DETAILED DESCRIPTION

A description of example embodiments follows.

The systems and methods disclosed herein allow a driver to plan stop-overs (waypoints) at the beginning of a trip or after the driver has started the trip using smart personalized search algorithms for finding optimal waypoints. During the trip, the system can perform context-aware monitoring that can add or adjust waypoints in response to changing circumstances. The waypoint adjustment can be triggered not only by user requests (e.g., verbal or haptic interaction), but also by signals from in-car sensors (e.g., low fuel/battery detection, drowsiness detection). The waypoint adjustment can be performed whether there is a navigation route being followed by the driver, or when no route guidance is currently active.

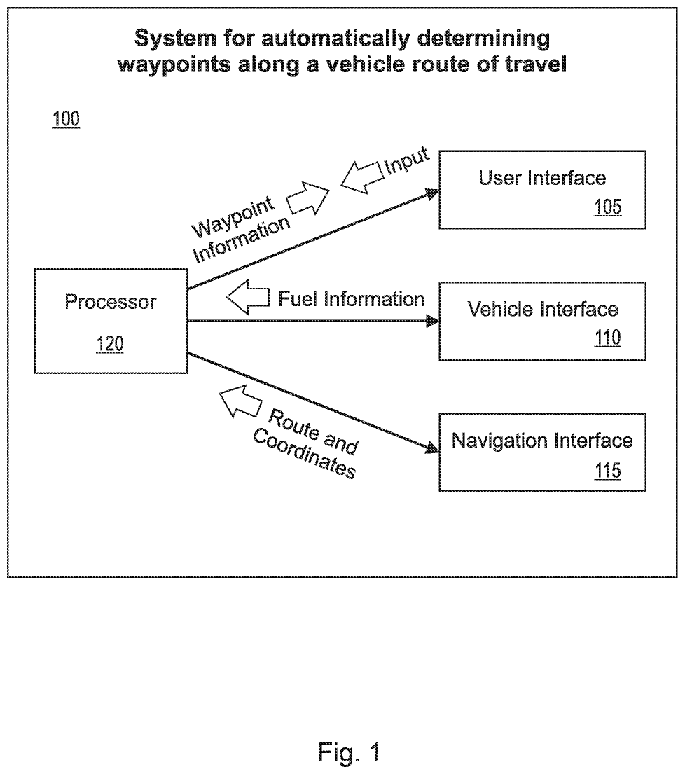

FIG. 1 is a block diagram illustrating a system 100 for automatically determining waypoints along a vehicle route of travel, according to an example embodiment. The example system 100 can be an apparatus that is installed into a vehicle, for example, and connected with various components of the vehicle. The apparatus may be hard-wired into the vehicle, or can be connected with the vehicle's components via wireless connection(s). The example system 100 includes a user interface 105, vehicle interface 110, navigation interface 115, and a processor 120 in communication with the user interface 105, vehicle interface 110, and navigation interface 115.

The user interface 105 can be a touch screen interface that is integrated within the dashboard of a vehicle, for example, or can be a standalone apparatus that is mounted within the vehicle. The user interface 105 is configured to present information (e.g., route of travel or waypoints) to a driver of the vehicle and to accept input (e.g., commands) from the driver. Alternatively, or in addition to the touch screen embodiment, the user interface 105 can include a voice interface.

The vehicle interface 110 can communicate with an on-board computer of the vehicle using, for example, an application programming an interface (API). The vehicle interface 110 is configured to determine an amount of fuel remaining in the vehicle, which the system 100 can use to determine and suggest waypoints for the driver. Alternatively, or in addition to fuel level, the vehicle interface 110 can be configured to determine information regarding a drowsiness level of the driver, which the system 100 can use to determine and suggest waypoints for the driver.

The navigation interface 115 can interface with an on-board computer of the vehicle, which may or may not be the same on-board computer that interfaces with the vehicle interface 110. The navigation interface 115 is configured to determine a route of travel and determine positioning coordinates of the vehicle, which can be obtained from a vehicle on-board computer, or from a separate global positioning system (GPS) component.

The system 100 can also include a waypoint information interface (not shown), such as a connection to the internet (e.g., via cellular data, WiFi, or Bluetooth) to determine information regarding candidate waypoints, such as operating times of establishments that are at the waypoints. In such embodiments, the system 100 can determine a candidate waypoint based on whether an establishment at the waypoint is open at an estimated time of arrival at the waypoint.

The processor 120 is configured to determine at least one candidate waypoint to add to the route of travel based on the amount of fuel remaining in the vehicle (or driver drowsiness) and driver preference factors. The driver preference factors can include, for example, a price factor or a convenience factor. The processor 120 can determine scores for a plurality of candidate waypoints based on the driver preference factors, and can cause the user interface 105 to present a list of candidate waypoints having the highest scores. The processor 120 can update the driver preferences based on a selection, via the user interface 105, of a candidate waypoint by the driver.

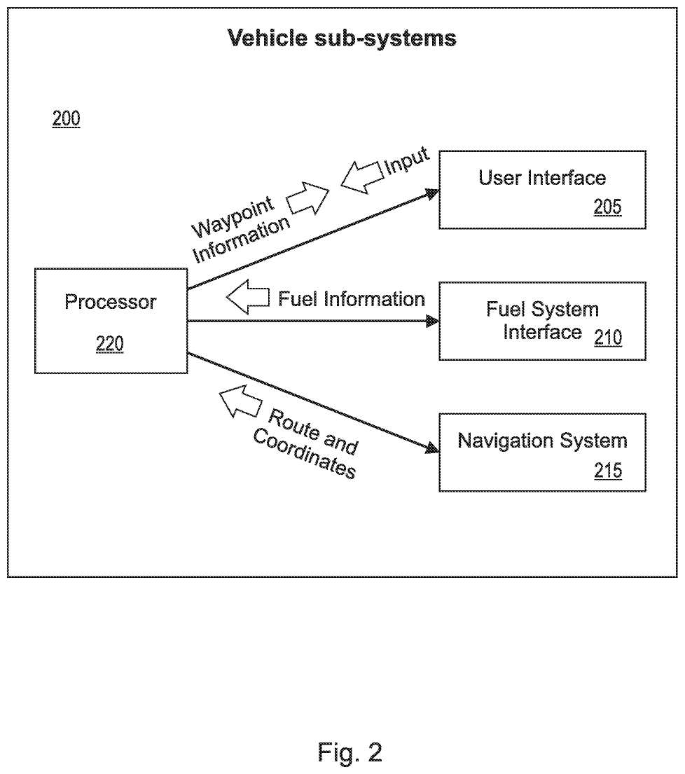

FIG. 2 is a block diagram illustrating vehicle subsystems for automatically determining waypoints along a vehicle route of travel, according to an example embodiment. The subsystems include a user interface 205, fuel system interface 210, navigation system 215, and processor 220 in communication with the user interface 205, fuel system interface 210, and navigation system 215.

The user interface 205 can be a touch screen interface that is integrated within the dashboard of the vehicle, for example, or can be a display that is mounted within the vehicle. The user interface 205 is configured to present information (e.g., route of travel or waypoints) to a driver of the vehicle and to accept input (e.g., commands) from the driver. Alternatively, or in addition to the touch screen embodiment, the user interface 205 can include a voice interface.

The fuel system interface 210 can communicate with an on-board computer of the vehicle using, for example, an application programming an interface (API). The fuel system interface 210 is configured to determine an amount of fuel remaining in the vehicle, which the processor 220 can use to determine and suggest waypoints for the driver.

The vehicle can further include a driver drowsiness detector (not shown) configured to determine information regarding a drowsiness level of the driver, which the processor 220 can use to determine and suggest waypoints for the driver.

The navigation interface 215 can interface with an on-board computer of the vehicle, which may or may not be the same on-board computer that interfaces with the fuel system interface 210. The navigation interface 215 is configured to determine a route of travel and determine positioning coordinates of the vehicle, which can be obtained from an on-board computer, or from a separate global positioning system (GPS) component.

The vehicle can further include a computer network interface (not shown), such as a connection to the internet (e.g., via cellular data, WiFi, or Bluetooth), to determine information regarding candidate waypoints, such as operating times of establishments that are at the waypoints. In such embodiments, the processor 220 can determine a candidate waypoint based on whether an establishment at the waypoint is open at an estimated time of arrival at the waypoint.

The processor 220 is configured to determine at least one candidate waypoint to add to the route of travel based on the amount of fuel remaining in the vehicle (or driver drowsiness) and driver preference factors. The driver preference factors can include, for example, a price factor or a convenience factor. The processor 220 can determine scores for a plurality of candidate waypoints based on the driver preference factors, and can cause the user interface 205 to present a list of candidate waypoints having the highest scores. The processor 220 can update the driver preferences based on a selection, via the user interface 205, of a candidate waypoint by the driver.

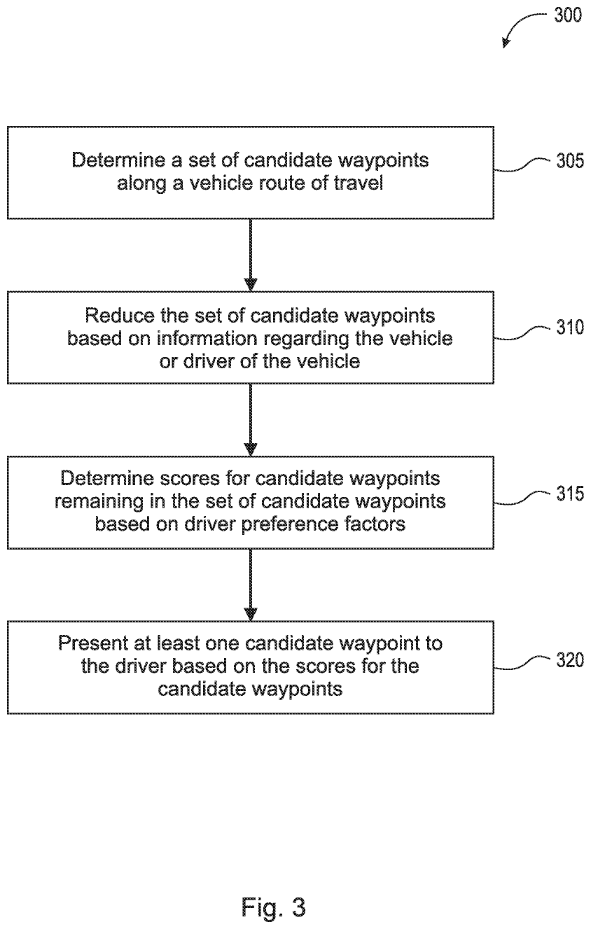

FIG. 3 is a flow diagram illustrating a method 300 of automatically determining waypoints along a vehicle route of travel, according to an example embodiment. In determining at least one candidate waypoint to present to the driver, the above apparatus and system, or other apparatus or systems, can employ the following example method 300, which includes determining 305 a set of candidate waypoints along the route of travel, and reducing 310 the set of candidate waypoints based on information regarding the vehicle or driver of the vehicle. Reducing the set of candidate waypoints can include, for example, removing a candidate waypoint from the set of candidate waypoints if the candidate waypoint is not reachable. Determining whether a candidate waypoint is reachable can be based on an amount of fuel remaining in the vehicle, level of driver drowsiness, or whether an establishment at the candidate waypoint is open at an estimated time of arrival at the candidate waypoint. The method 300 further includes determining 315 scores for candidate waypoints remaining in the set of candidate waypoints based on driver preference factors, and presenting 320 at least one candidate waypoint to the driver based on the scores for the candidate waypoints. Determining scores for candidate waypoints can include determining a score for a candidate waypoint based on a price factor or a convenience factor, and presenting the at least one candidate waypoint to the driver can include presenting a list of candidate waypoints having the highest scores. The method 300 can further include updating the driver preferences based on a selection of a candidate waypoint by the driver.

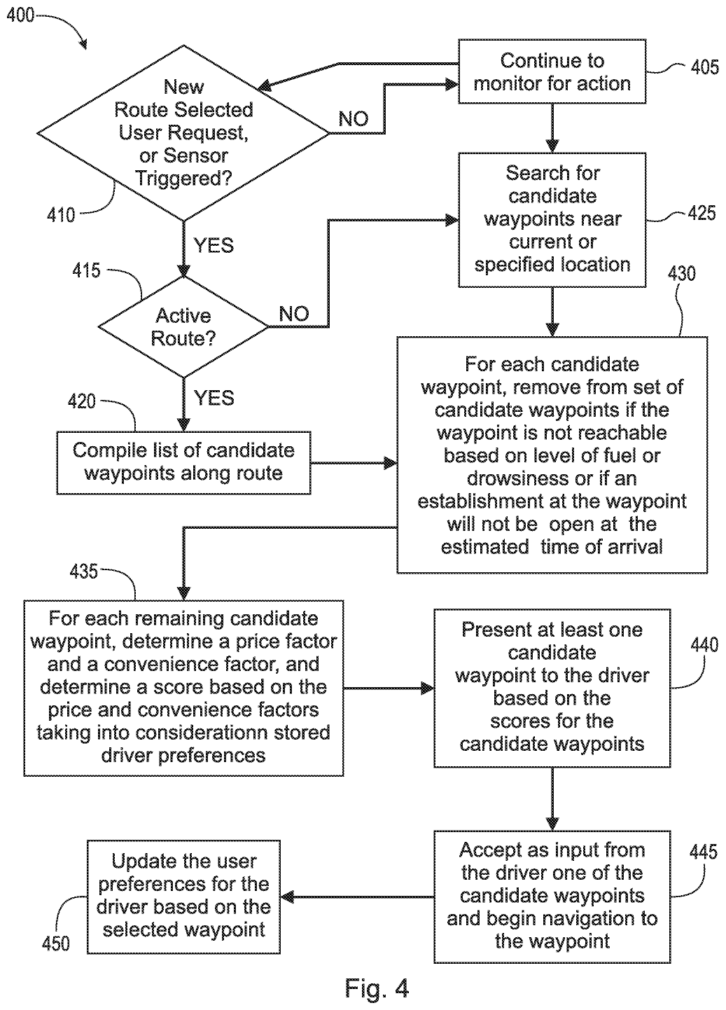

FIG. 4 is a flow diagram illustrating a method 400 of automatically determining waypoints along a vehicle route of travel, according to an example embodiment. According to the example method 400, a system monitors 405 for a condition 410 that prompts the system to take action. Some example conditions are: (1) at the beginning of a trip when a driver requests the system to navigate to a given destination, (2) in response to a low fuel or drowsy driver condition, (3) and upon driver request. In the case where a driver requests the system to navigate to a given destination, the system can assess whether the distance to the destination exceeds the current fuel/battery range (provided by a fuel level sensor/battery state monitor and on-board computer), and whether the expected duration of the trip is greater than the personalized recommended consecutive driving time. The system can also verify that candidate POIs will be open when the driver arrives. If either or both of these conditions holds, the system can perform a gas-station/EV charger and/or rest-stop search at optimal route segments and add one or more of the results as dynamic waypoints to the route. If at any point the in-car fuel/battery level sensor triggers a reserve-fuel/low-energy signal, a proactive gas station/EV charger search interaction can be triggered. Likewise, a proactive rest-stop search interaction can be triggered by an in-car driver drowsiness detector. Such a feature can be available if there is no active route guidance, or if there is an active navigation but the driver had earlier declined to schedule rest-stop or refueling/recharging waypoints on the route. The driver can also prompt the system at any time to find a gas station/EV charger or a rest stop. If there is an active route in progress, the system can perform 420 a search along the route taking into consideration the current fuel/battery range as well as any personalized recommended consecutive driving time. In addition, the driver can specify a distance along the route where the driver wants the system to focus the search. If there is no active route, the system can perform the search 425 around the current location or around any other user-specified location.

The system compiles a list of candidate waypoints, which can be reduced 430 based on determinations that certain waypoints are not reachable based on level of fuel or drowsiness or if establishments at the waypoints will not be open at the estimated time of arrival. That is, initially, a list of candidate POIs of a requested type (gas station, rest stop, restaurant, car park, etc.) along the route are retrieved. In reducing the list, information that can be considered includes vehicle sensor information, such as fuel level/driving range sensor (if the currently selected fuel stop cannot be reached due to low fuel, another gas station can be selected) or a drowsiness sensor (if the sensor detects that the driver is getting tired, another rest stop can be selected). A waypoint may also have opening hours that can affect whether the waypoint can be reached in time.

For each remaining candidate waypoint, the system can determine 435 a price factor and a convenience factor, and determine a score based on the price and convenience factors taking into consideration stored driver preferences. A convenience factor can represent the detour required to reach the waypoint and continue the route afterwards. The price factor can represent the expected cost of the stop, which is relevant for gas stations and restaurants. Both of these example factors can be represented as a number between 0 and 1, where 1 is the best (e.g., closest, cheapest) and 0 the worst (e.g., farthest, most expensive). Additional properties of the waypoint that can play a role in a specific driver's preference for that waypoint can include a category of the waypoint (e.g., cuisine type for restaurants, brands for rest stops). The driver's preference for these categories can also be represented as a number between 0 and 1.

An example of a price factor for a gas station is as follows:

A is the estimated fuel to be consumed from current location to gas station

A=distance to station*current average consumption

B is the estimated vehicle fuel level when arriving at gas station

B=current fuel level−A

C is the estimated cost of fuel fill up

C=(maximum fuel level−B)*fuel price at gas station

D is the estimated fuel to be consumed from the gas station to the destination

D=distance from station to destination*current average consumption

E is the estimated fuel cost from gas station to destination

E=D*fuel price at gas station

Z=C+E

Select the gas station that minimizes Z

Examples of a convenience factor for a given waypoint include the amount of time required for the detour to reach the waypoint, and the distance added to the route in order to reach the waypoint.

Driver preferences for these factors can be modeled by keeping a tally of how often a driver chooses a specific option or not (e.g., selecting a gas station with the lowest price as opposed to the closest gas station). The following is an example equation for use with driver preferences:

$$user\_preferenceA = \frac{countA + priorA}{countA + countB + priorA + priorB}$$

countA: A count of how often the driver has chosen optionA (e.g., cheap gas station);
countB: A count of how often the driver has chosen the opposite (e.g., close gas station);
priorA: An initial value relating to countA;
priorB: An initial value relating to countB;
user_preferenceA: The preference a driver has for optionA (e.g., cheap gas stations), ranging from 1 (very strong preference) to 0 (very strong negative preference).

The prior values allow the formula to be initialized to something sensible if no or very little data is initially present. With small priors, driver choices are considered fairly quickly. With large priors, many observations are needed to move the preference significantly from the default initialization.

When the candidate waypoint(s) have been determined, the system can present 440 at least one candidate waypoint to the driver based on the scores for the candidate waypoints. For example, a list of all or a subset of the candidate waypoint may be presented to the driver, where the waypoints with the highest scores appear first, at the top of the list. Alternatively, the system can choose the waypoint with the highest score and offer that waypoint to the driver. The system accepts 445 as input from the driver one of the candidate waypoints and begins navigation to the waypoint. The system can use the selection by the driver to update 450 the user preferences for the driver based on the selected waypoint.

Once the user accepts a suggested waypoint (e.g., rest-stop and/or gas station/EV charging station), it is added as a dynamic waypoint to an ongoing navigation. If there was previously no active navigation, a new route guidance can be started. The system can continue to monitor for conditions that prompt determination of new or additional waypoints. If anywhere along the trip the traffic or driving conditions change significantly so as to affect the fuel/battery consumption and/or the progress along the route, the dynamic rest-stop/gas station/EV charger waypoints can be re-calculated and a proactive user interaction can be triggered. Similarly, if a currently selected waypoint, according to its opening hours, will be closed due to delays, a new proactive user interaction can be triggered.

The following is example computer pseudocode for implementing aspects of the disclosed systems and methods:

IF (startOfRoute OR userRequest OR sensorTrigger):

scoredResultList = CALL computeBestPoi;
present scoredResultList to user;
selectedPOI = user choice from scoredResultList;
set selectedPOI in navigation system;
update user preferences based on selectedPOI;

// a Navigation Route R is expressed as a Path P of lat/long Coordinates C_1, ..., C_n
// simplest interface to a geographic information system (GIS) or a map data provider
// is assumed to be a radius search around a given lat/long coordinate

| | |
|---|---|
| // | −> getCandidatesAroundLatLong(coordinate, radius) |

// GIS/map database can be a cloud content provider, or a local navigation database
// Search Radius SR determined by the application designer, or based on user preference
FUNCTION generatelnitialCandidatesList:
initial_candidates_set = empty set;

for each C_i in P do {
initial_candidates_set = set_union(initial_candidates_set,
getCandidatesAroundLatLong(C_i, SR));

}
initial_candidates_list = convertToList(initial_candidates_set);
return initial_candidates_list
FUNCTION computeBestPoi:
candidatePoiList = generateInitialCandidatesList;
scoredResultList = empty list;
for each candiadatePoi in candidatePoiList:

remove if not reachable considering fuel level;
remove if not reachable considering drowsiness;
remove if not open upon arrival;

for each candiadatePoi in candidatePoiList:

determine price_factor;
determine convenience_factor;

retrieve user_preference_for_price;
retrieve user_preference_for_convenience;
for each additional POI property p:

determine additional factor p;
retrieve user preference for p;

scoredPOI = scorePOI(candiadatePoi);
add scoredPOI to scoredResultList;
return scoredResultList
FUNCTION scorePOI:
score = (price_factor * user_preference_for_price

+ convenience factor * user_preference_for_convenience
+ factor_p1 * user_preferencep1
+ ...
+ factor_pn * user_preference_pn)
/ (n+2);

return score

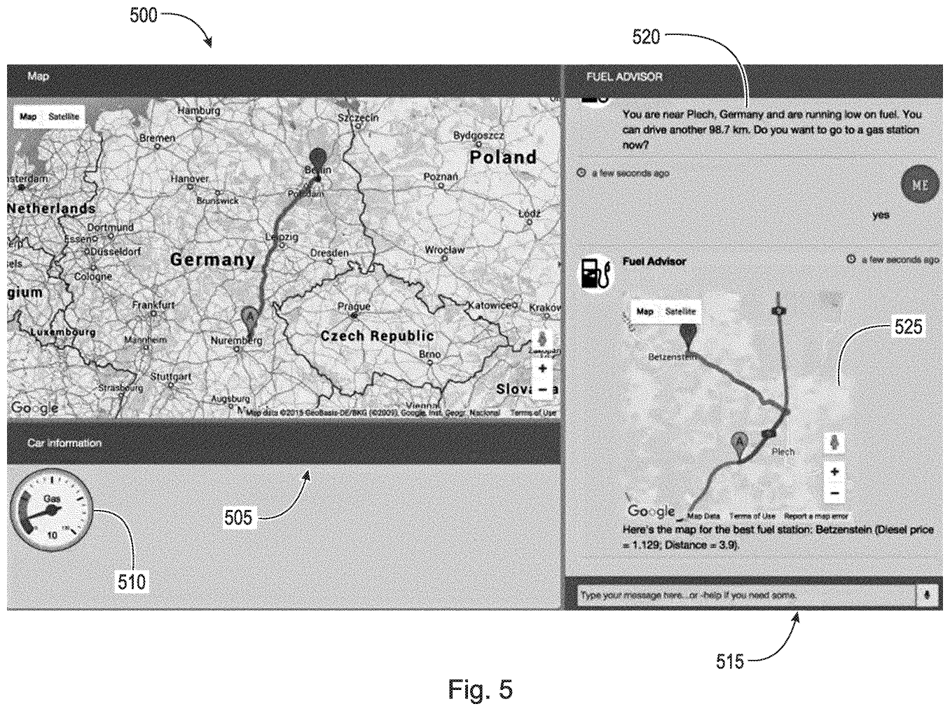

FIG. 5 illustrates an example user interface 500 of a system for automatically determining waypoints along a vehicle route of travel. Section 505 of the example interface 500 depicts a map with the vehicle's current planned route of travel. Indicator 510 depicts a representation of the amount of fuel remaining the vehicle. Section 515 of the interface 500 depicts an interaction between the driver and system. For example, 520 shows a prompt from the system to the driver indicating that the vehicle is low on fuel, and 525 is a presentation of a waypoint suggested by the system.

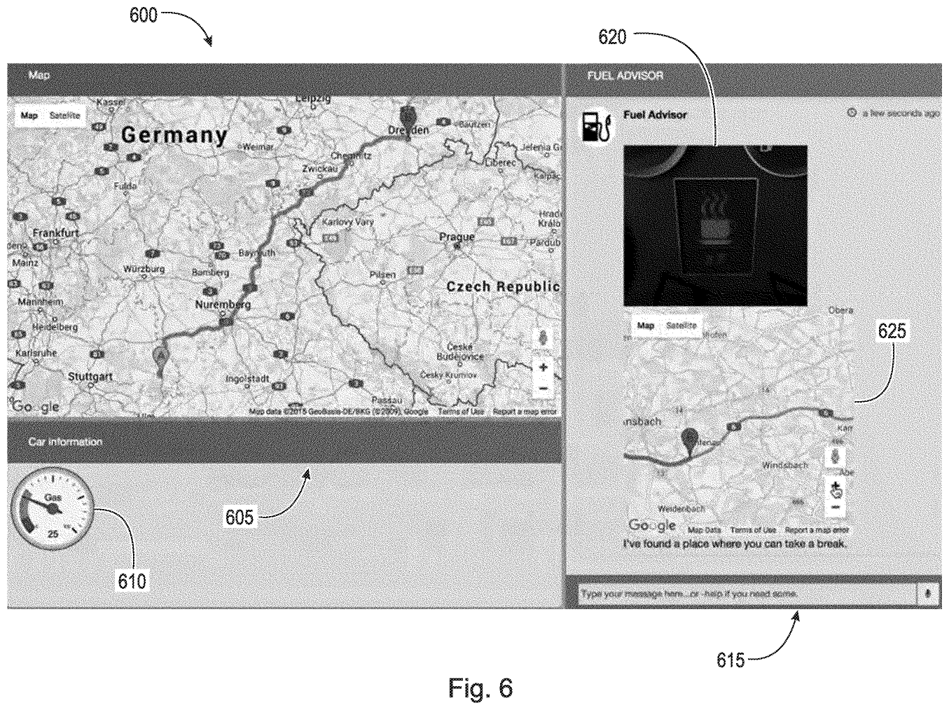

FIG. 6 illustrates an example user interface 600 of a system for automatically determining waypoints along a vehicle route of travel. Section 605 of the example interface 600 depicts a map with the vehicle's current planned route of travel. Indicator 610 depicts a representation of the amount of fuel remaining the vehicle. Section 615 of the interface 600 depicts an interaction between the driver and system. For example, 620 shows a prompt from the system to the driver indicating that the vehicle has detected that the driver may be drowsy, and 625 is a presentation of a waypoint suggested by the system.

While example embodiments have been particularly shown and described, it will be understood by those skilled in the art that various changes in form and details may be made therein without departing from the scope of the embodiments encompassed by the appended claims. For example, as presented herein a driver of a vehicle is described as interacting with the systems, but another passenger in the vehicle can also interact with the system. Further, the vehicle can include cars, trucks, motorcycles, bicycles, or other modes of transportation.

What is claimed is:

1. A system for automatically determining waypoints along a vehicle route of travel, the system comprising:
a user interface configured to present information to a driver of the vehicle and to accept input from the driver;
a vehicle interface configured to determine an amount of fuel remaining in the vehicle;
a navigation interface configured to (i) determine a route of travel and (ii) determine positioning coordinates of the vehicle; and
a processor in communication with the user interface, vehicle interface, and navigation interface, and configured to (i) determine at least one candidate waypoint to add to the route of travel based on the amount of fuel remaining in the vehicle and driver preference factors, and (ii) cause the user interface to present the at least one candidate waypoint.

2. A system as in claim 1 wherein the vehicle interface is further configured to determine information regarding a drowsiness level of the driver, and the processor is further configured to determine at least one candidate waypoint based on the drowsiness level of the driver.

3. A system as in claim 1 further comprising a waypoint information interface configured to determine information regarding candidate waypoints, and the processor is further configured to determine at least one candidate waypoint based on whether an establishment at a waypoint is open at an estimated time of arrival at the waypoint.

4. A system as in claim 1 wherein the driver preference factors include a price factor or a convenience factor.

5. A system as in claim 1 wherein the processor is further configured to (i) determine scores for a plurality of candidate waypoints based on the driver preference factors, and (ii) cause the user interface to present a list of candidate waypoints having the highest scores.

6. A system as in claim 1 wherein the processor is further configured to update the driver preferences based on a selection, via the user interface, of a candidate waypoint by the driver.

7. A system as in claim 1 wherein the user interface is a touch screen interface or voice interface.

8. A method of automatically determining waypoints along a vehicle route of travel, the method comprising:
determining a set of candidate waypoints along the route of travel;
reducing the set of candidate waypoints based on information regarding the vehicle or driver of the vehicle;
determining scores for candidate waypoints remaining in the set of candidate waypoints based on driver preference factors; and
presenting at least one candidate waypoint to the driver based on the scores for the candidate waypoints.

9. A method as in claim 8 wherein reducing the set of candidate waypoints includes removing a candidate waypoint from the set of candidate waypoints if the candidate waypoint is not reachable.

10. A method as in claim 9 further comprising determining whether a candidate waypoint is reachable based on an amount of fuel remaining in the vehicle, level of driver drowsiness, or whether an establishment at the candidate waypoint is open at an estimated time of arrival at the candidate waypoint.

11. A method as in claim 8 wherein determining scores for candidate waypoints includes determining a score for a candidate waypoint based on a price factor or a convenience factor.

12. A method as in claim 8 wherein presenting the at least one candidate waypoint to the driver includes presenting a list of candidate waypoints having the highest scores.

13. A method as in claim 8 further comprising updating the driver preferences based on a selection of a candidate waypoint by the driver.

14. A vehicle comprising:
a user interface configured to present information to a driver of the vehicle and to accept input from the driver;
a fuel system interface configured to determine an amount of fuel remaining in the vehicle;
a navigation system configured to (i) determine a route of travel and (ii) determine positioning coordinates of the vehicle; and
a processor in communication with the user interface, fuel system interface, and navigation system, and configured to (i) determine at least one candidate waypoint to add to the route of travel based on the amount of fuel remaining in the vehicle and driver preference factors, and (ii) cause the user interface to present the at least one candidate waypoint.

15. A vehicle as in claim 14 further including a driver drowsiness detector configured to determine information regarding a drowsiness level of the driver, and wherein the processor is further configured to determine at least one candidate waypoint based on the drowsiness level of the driver.

16. A vehicle as in claim 14 further comprising a computer network interface configured to determine information regarding candidate waypoints, and wherein the processor is further configured to determine at least one candidate waypoint based on whether an establishment at a waypoint is open at an estimated time of arrival at the waypoint.

17. A vehicle as in claim 14 wherein the driver preference factors include a price factor or a convenience factor.

18. A vehicle as in claim 14 wherein the processor is further configured to (i) determine scores for a plurality of candidate waypoints based on the driver preference factors, and (ii) cause the user interface to present a list of candidate waypoints having the highest scores.

19. A vehicle as in claim 14 wherein the processor is further configured to update the driver preferences based on a selection, via the user interface, of a candidate waypoint by the driver.

20. A vehicle as in claim 14 wherein the user interface is a touch screen interface or voice interface.
